(19) United States
(12) Patent Application Publication
(10) Pub. No.: US 2024/0220572 A1
(43) Pub. Date: Jul. 4, 2024

(54) PIPELINE-PARALLEL-DATAFLOW ARTIFICIAL INTELLIGENCE SYSTEM FOR ACCELERATING SELF-ATTENTION COMPUTATIONS

(71) Applicant: International Business Machines Corporation, Armonk, NY (US)

(72) Inventors: Shubham Jain, Elmsford, NY (US); Geoffrey Burr, Cupertino, CA (US); HsinYu Tsai, Cupertino, CA (US); Yasuteru Kohda, Yamato-shi (JP); Milos Stanisavljevic, Langnau am Albis (CH)

(21) Appl. No.: 18/092,183

(22) Filed: Dec. 30, 2022

(51) Int. Cl. G06F 17/16; G06F 7/50; G06F 7/523; G06F 7/535; G06F 7/556

(52) U.S. Cl. CPC G06F 17/16; G06F 7/50; G06F 7/523; G06F 7/535; G06F 7/556

(57) ABSTRACT

A compute engine is configured to perform self-attention computations by delaying performance of a division operation of a softmax computation, the performance including iteratively computing a first matrix multiplication of a given row vector of a first matrix and each column vector of a second matrix while determining a first scalar element representing a maximum value of the iterative first matrix multiplications; iteratively subtracting a corresponding determined first scaler element from a result of each computed first matrix multiplication and computing an elementwise exponential function based on a result of the subtraction operation to generate a plurality of elements of a given row vector of a fourth matrix; iteratively computing a second matrix multiplication of a given row vector of the fourth matrix and each column vector of a third matrix while summing the given row vectors of the fourth matrix; and computing a row vector of an output matrix.

### BACKGROUND

The present invention relates generally to the electrical, electronic and computer arts and, more particularly, to machine learning systems.

Self-attention blocks have emerged as a popular compute kernel in, for example, state-of-the-art natural language processing (NLP) models. They offer superior accuracy over prior mechanisms. Self-attention acceleration is not a problem for a digital accelerator; however, for analog AI systems, self-attention becomes a substantial bottleneck regardless of sequence length, but it is especially a problem since the self-attention grows quadratically with sequence length (matrix-matrix (MM) multiplication is linear in the number of tokens (SL), however self-attention (SA) kernel is quadratic in SL). It is noted that analog AI accelerators are best suited for matrix-matrix multiplications between a weight matrix and an activation matrix (i.e., where one matrix is not dynamic) and generally perform poorly between two activation matrices (i.e., where both matrices are dynamic). Thus, in general, the overall performance of next generation artificial intelligence (AI) accelerators (that is, analog AI accelerators) is limited by the self-attention layers. Accelerating self-attention is therefore quite pertinent to the overall performance of workloads on artificial intelligence (AI) platforms.

### BRIEF SUMMARY

Principles of the invention provide a pipeline-parallel-dataflow artificial intelligence system for accelerating self-attention computations. In one aspect, an exemplary method includes the operations of pushing a given row vector of a first matrix; pushing a column vector of a second matrix on each of a plurality of clock cycles; and pushing a column vector of a third matrix on each of the plurality of clock cycles after a given delay.

In one aspect, a method for performing self-attention computations by delaying performance of a division operation of a softmax computation includes the operations of iteratively computing a first matrix multiplication of a given row vector of a first matrix and each column vector of a second matrix while determining a first scalar element representing a maximum value of the iterative first matrix multiplications; iteratively subtracting a corresponding determined first scaler element from a result of each computed first matrix multiplication and computing an elementwise exponential function based on a result of the subtraction operation to generate a plurality of elements of a given row vector of a fourth matrix; iteratively computing a second matrix multiplication of a given row vector of the fourth matrix and each column vector of a third matrix while summing the given row vectors of the fourth matrix to obtain a second scalar; and computing a row vector of an output matrix based on results of the second matrix multiplications.

In one aspect, a compute engine is configured to perform self-attention computations by delaying performance of a division operation of a softmax computation, the performance of the self-attention computations including iteratively computing a first matrix multiplication of a given row vector of a first matrix and each column vector of a second matrix while determining a first scalar element representing a maximum value of the iterative first matrix multiplications; iteratively subtracting a corresponding determined first scaler element from a result of each computed first matrix multiplication and computing an elementwise exponential function based on a result of the subtraction operation to generate a plurality of elements of a given row vector of a fourth matrix; iteratively computing a second matrix multiplication of a given row vector of the fourth matrix and each column vector of a third matrix while summing the given row vectors of the fourth matrix to obtain a second scalar; and computing a row vector of an output matrix based on results of the second matrix multiplications.

As used herein, “facilitating” an action includes performing the action, making the action easier, helping to carry the action out, or causing the action to be performed. Thus, by way of example and not limitation, instructions executing on a processor might facilitate an action carried out by semiconductor fabrication equipment, by another processor, or the like, by sending appropriate data or commands to cause or aid the action to be performed. Where an actor facilitates an action by other than performing the action, the action is nevertheless performed by some entity or combination of entities.

Techniques as disclosed herein can provide substantial beneficial technical effects. Some embodiments may not have these potential advantages and these potential advantages are not necessarily required of all embodiments. By way of example only and without limitation, one or more embodiments may provide one or more of:

special-purpose, pipelined compute hardware for efficient reduced-precision transformer attention computations;

closely connected staging static random-access memory (SRAM) for holding and efficient access to the Q, K, and V matrices of the self-attention computations;

high throughput resulting from a pipelined architecture where one V and one K vector are retrieved from SRAM and injected into the compute-hardware per cycle;

high energy-efficiency (achieving an estimated 7.3, 8.9 and 11.4 tera-operations per second/Watt (TOPS/W) for the Q*K, P*V and softmax portions of the self-attention computations, respectively);

improved area-efficiency (approximately half the circuit area dedicated to staging SRAM and half to parallel digital compute circuitry);

potentially applicable/valuable for building accelerators to implement Transformers or other networks that rely on “attention compute”;

tightly-pipelined and reduced-precision computations;

implicit transpose operations through a multiplier/adder organization;

customized look-up tables (LUTs) for sub-computations;

design recipes for substantial acceleration of self-attention kernels on in-memory AI computing systems;

an optimized softmax computation achieved by i) rewriting the e^{K*Q[s]} term of the softmax computation as e^{K*Q[s]-MAX(K*Q[s])} and by ii) postponing the summation and normalization sub-operations until after the matrix computation P*V; and

alleviation of the main performance bottleneck in popular Bidirectional Encoder Representations from Transformers (BERT) and language AI models realized on analog AI hardware.

These and other features and advantages will become apparent from the following detailed description of illustrative embodiments thereof, which is to be read in connection with the accompanying drawings.

### BRIEF DESCRIPTION OF THE DRAWINGS

The following drawings are presented by way of example only and without limitation, wherein like reference numerals (when used) indicate corresponding elements throughout the several views, and wherein:

FIG. 1 is a graphic illustration of the specific conventional computation performed by each attention-head;

FIG. 2 illustrates a block diagram of an example K-Q stage of an attention-compute pipeline, in accordance with an example embodiment;

FIG. 3 illustrates a block diagram of a softmax stage (stage 2) that processes the intermediate vector of length S produced by the K-Q stage 222, in accordance with an example embodiment;

FIG. 4 illustrates a graph of the exponential function implemented by the exponential calculator and the FMA unit, in accordance with an example embodiment;

FIGS. 5A and 5B illustrate a technique for performing an eleven-bit by ten-bit multiplication using a nine-bit by ten-bit multiplier, in accordance with an example embodiment;

FIG. 6 illustrates a block diagram of a P-V stage (stage 3) that sequentially processes S intermediate values from the softmax stage, in accordance with an example embodiment;

FIG. 7 illustrates graphs utilized in implementing the inversion table calculator with FMA compensator, in accordance with an example embodiment;

FIG. 8A is a block diagram of a first parallel implementation utilizing a plurality of compute engines, in accordance with an example embodiment;

FIG. 8B is a block diagram of a second parallel implementation utilizing the above architecture, in accordance with an example embodiment;

FIG. 8C is a block diagram of a third parallel implementation utilizing the above architecture, in accordance with an example embodiment;

FIG. 9 illustrates the matrix architecture for a computation engine (also referred to as a special function unit herein), in accordance with an example embodiment;

FIG. 10 depicts a computing environment that can be used in connection with the design process of FIG. 13; and

FIG. 11 is a flow diagram of a design process used in semiconductor design, manufacture, and/or test.

It is to be appreciated that elements in the figures are illustrated for simplicity and clarity. Common but well-understood elements that may be useful or necessary in a commercially feasible embodiment may not be shown in order to facilitate a less hindered view of the illustrated embodiments.

### DETAILED DESCRIPTION

Principles of inventions described herein will be in the context of illustrative embodiments. Moreover, it will become apparent to those skilled in the art given the teachings herein that numerous modifications can be made to the embodiments shown that are within the scope of the claims. That is, no limitations with respect to the embodiments shown and described herein are intended or should be inferred.

Generally, exemplary embodiments of a pipeline compute architecture and pipeline-parallel-dataflow system for accelerating self-attention computations are disclosed. A Transformer deep neural network (DNN) typically operates on a sequence of length S, with each token in the sequence being encoded into a vector of a given width N (where, for example, N equals 512, 768 or 1024 elements). Each token may be, for example, a word, and each sequence may be a sentence or a paragraph. In one example embodiment, a fine-grained spatial work division of the self-attention compute workload accelerates each head of a multi-headed self-attention kernel with the assistance of an interleaving mechanism that minimizes storage overheads. In general, there are two main blocks within the Transformer network:
1) fully connected layers, which independently produce one output excitation vector for each input excitation vector by performing vector-matrix multiplication against a matrix of previously-trained weights (in the context of Analog-AI, these operations can very efficiently be performed on crossbar arrays); and
2) the “attention compute,” which takes in multiple excitation-vectors spanning the entire sequence of length S, produces an “attention matrix” as an intermediate result, and then produces one output excitation-vector per token in the sequence.

Typically, this attention compute is performed after first breaking three incoming vectors of length N, known as the Key (K), Query (Q), and Value (V) vectors, into sub-vectors of length M. (In a non-limiting example, M equals 64.) The independent computation performed on the set of K, Q, and V matrices of size M by S is known as an “attention-head.” (In a non-limiting example, S equals 64.) Once input vectors are sliced into the appropriate sub-vectors, computations can be performed on each attention-head in parallel and the N/M different output sub-vectors concatenated afterwards. The specific computation performed by each attention-head can be written out as softmax(Q*K^{T})*V. (In practice, in one or more embodiments, softmax(Q*K^{T})*V is actually computed as softmax(Q*K^{T}/\sqrt{dk})*V where dk typically equals 64.)

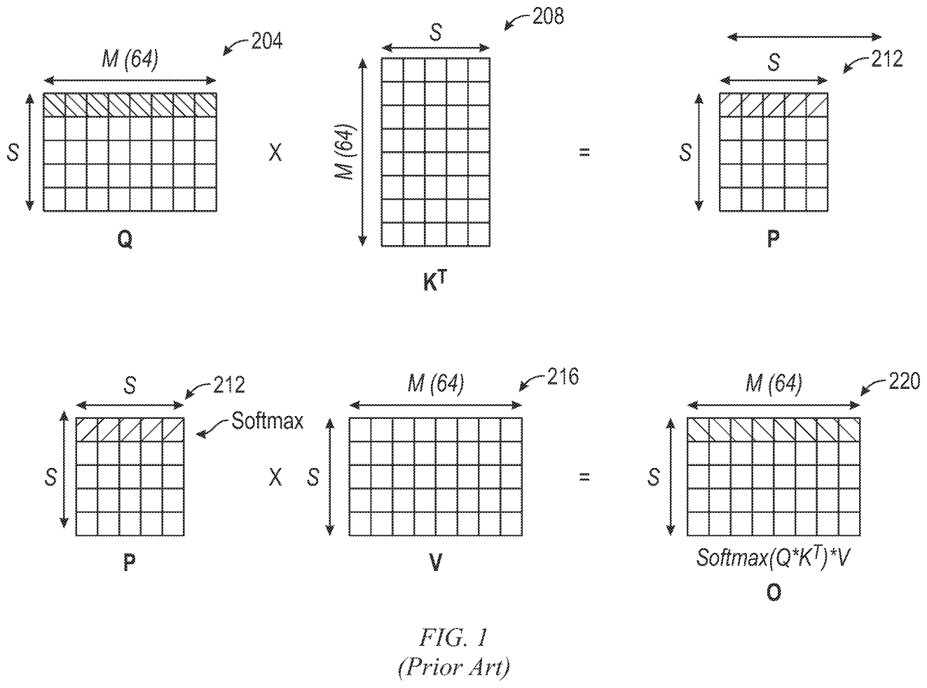

FIG. 1 is a graphic illustration of the specific conventional computation performed by each attention-head. First, the Q matrix 204 and the K matrix 208, each of size S×M, are multiplied, producing an intermediate P matrix 212 of size S×S. Softmax operations are performed individually on each row of the P matrix 212 (putting the terms through an expo operation and then normalizing the sum to 1.0), and then this row-normalized P matrix 212 is multiplied by the V matrix 216 to produce an output matrix 220 (designated O matrix 220 herein), where both the V matrix 216 and the O matrix 220 are of size S×M.

Since the attention compute is essentially matrix-matrix multiplications between just-computed excitations, it does not lend itself well to implementation on analog-AI crossbars. For example, self-attention computations do not map well to Analog-AI crossbars as the matrix-matrix multiplications are between two activation matrices (and not a weight matrix and an activation matrix). Technically, these calculations could be performed by SRAM-based Compute-In-Memory techniques, but the presence of the transpose operation, and the typical need to robustly support sparse tiling of the attention matrix, make this difficult.

High operand reuse, such as with the data elements in the K and Q matrices, benefit from fast on-chip memory (such as SRAM). In one example embodiment, given that the matrix-matrix operations naturally call for repeated access to all rows in at least two of the K matrix 208, the Q matrix 204, and the V matrix 216, the recently-computed vectors or sub-vectors of these matrices are stored in SRAM. However, having access to these vectors that is both convenient and uses low-energy becomes a challenge. Furthermore, the aggressive scaling (such as scaling as S*S rather than linear scaling in S) of the number of compute-operations in the attention compute with sequence length S, means that it becomes important to achieve both reasonable throughput and energy-efficiency for these auxiliary operations.

In one example embodiment, special-purpose, pipelined computational hardware for efficient reduced-precision transformer attention computation is disclosed, where closely connected staging SRAMs hold the K matrix 208, the Q matrix 204, and the V matrix 216. The exemplary computational hardware can efficiently retrieve the K, Q, and V sub-vectors from the SRAM and perform the attention-compute operation with improved throughput and energy-efficiency. Exemplary advantages of one or more embodiments employing this approach are high throughput (since the computation is pipelined in stages and one V and K vector are retrieved from the SRAM and injected into the computational-hardware per cycle), high energy-efficiency (achieving an estimated 7.3, 8.9 and 11.4 TOPS/W for the Q*K, P*V and softmax portions, respectively), and good area-efficiency (generally, half the circuit area is dedicated to the staging SRAM and half the circuit area is dedicated to parallel digital computations). In one example embodiment, the pipeline includes a vector-compute engine with four main stages (where the softmax division operation is delayed in the pipeline).

### Stage 1: K-Q Stage

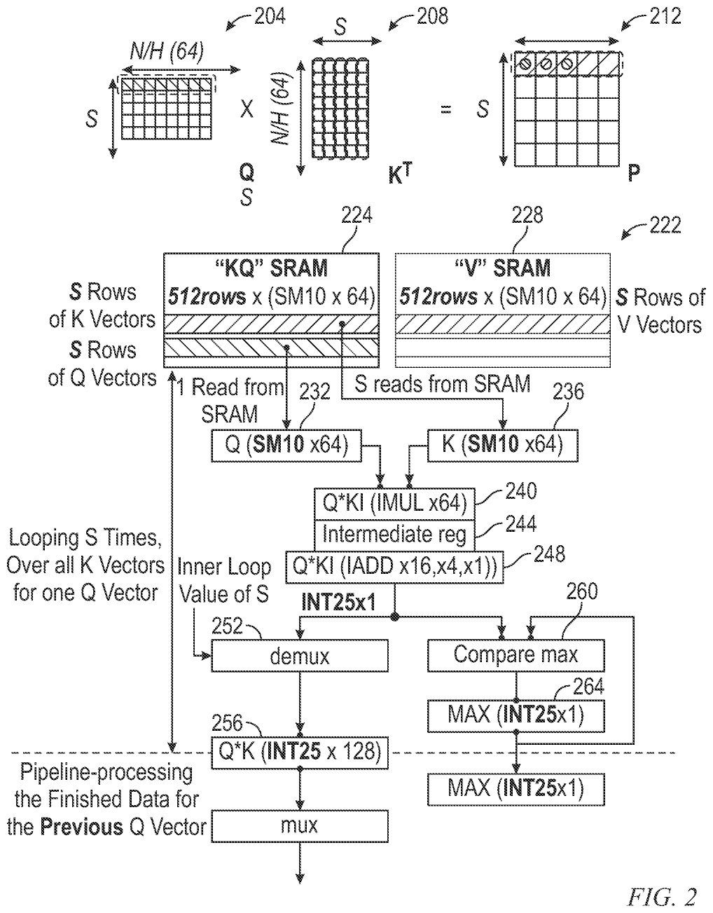

FIG. 2 illustrates a block diagram of an example K-Q stage 222 of an attention-compute pipeline, in accordance with an example embodiment. The K-Q stage 222 (also referred to as stage 1 herein) is designed to multiply one Q vector (of width M) against an entire K matrix 208 (all S vectors). (In a non-limiting example, one “attention head” has three different stored vectors (K, Q, and V) of integer elements, where each vector includes N/H elements (64 elements in the non-limiting example of FIG. 2).) The first step is to load the Q vector of interest from KQ SRAM 224 in, for example, one clock cycle. It is noted that reduced precision is used to help minimize the energy and area of the multipliers and adders, while still providing sufficient precision for accurate attention compute. In a non-limiting example, the precision of the Q vectors and the K vectors is ten bits.

A running MAX(operation is performed across the outgoing dot-product values associated with a given Q vector, representing an intermediate vector of size S. Once all S outgoing dot-product values are produced, the final MAX(value is saved in a second buffer for use in a subsequent stage of the pipeline. The main MAX(buffer is then reset to zero, the next Q vector is loaded from the SRAM 224, and the cycle repeats.

More specifically, in one example embodiment, one row of the Q matrix 204 is accessed and stored in Q register 232. One column of the K matrix 208 is accessed and stored in K register 236. (In one example embodiment, the loading of the K register 236 is performed in parallel with the loading of the Q register 232. In one example embodiment, the loading of the Q register 232 is performed just prior to the loading of the K register 236.) In a non-limiting example, the KQ SRAM 224 supports up to 64 elements per row and the Q register 232 and the K register 236 each support up to 64 elements.

Multiply operations are performed by integer multiply unit 240 and stored in intermediate register 244. As the integer multiply unit 240 includes a plurality of multiplication units, a plurality of elements of the Q vector may be multiplied by a corresponding element of the K vector in parallel. In a non-limiting example, the integer multiply unit 240 includes 64 multiplication units, meaning the entire Q vector is multiplied by the K vector in one step. Thus, M multiply operations are performed in parallel such that the M elements of a column of the K matrix 208 are multiplied by the M elements of a row of the Q matrix 204. The results of the multiplication operations are stored in intermediate register 244 and then summed by the Q*KI integer adder 248. The results of the summation are stored in the appropriate location (the location corresponding to the element of the row of the P matrix 212 that was calculated) of Q*K register 256 via the demultiplexer 256. The demultiplexer 252 outputs the summation result for storage in the Q*K register 256. In a non-limiting example, the precision of the result of the multiplication operation and the summation operation is 25 bits, and the Q*K register 256 supports 128 elements. The above operations are repeated for S steps (one iteration for each column of the K matrix 208). Thus, one Q vector of a row of the Q matrix 204 is read from the KQ SRAM 224 and stored in a Q register 232 for every S vectors of the K matrix 208 that are read from the KQ SRAM 224. After S steps, the Q*K register 256 contains the first row of the P matrix 212.

It is also noted that the calculation of the softmax in a later stage of the pipeline typically needs to know the value of the largest element in each row of the resulting P matrix 212. To facilitate the softmax calculation, a max register 264 is initialized to zero and revised to hold the largest value encountered as the results for each element of a given row of the P matrix 212 are calculated. As each multiplication result is calculated, it is compared to the current value in the max register 264 by comparator 260. If the value is less than or equal to the value in the max register 264, the value in the max register 264 is maintained; otherwise, the new multiplication result is stored in the max register 264.

Once all elements in a row of the P matrix 212 have been determined, the contents of the Q*K register 256 and the max register 264 are transferred to the next pipeline stage (stage 2). The max register 264 is also reset to zero and the circuitry of the K-Q stage 222 proceeds to process the next row of the Q matrix 204 and to produce the next row of the P matrix 212. It is noted that, in the non-limiting example of FIG. 2, the width of the Q*K register 256 is 128 and the precision is 25 bits. Thus, the width of the Q*K register 256 is 128 multiplied by the precision of 25 bits. Although the maximum value of S is 128, the number of iterations performed in stage 1 is based on the actual length S of the sequence.

### Stage 2

Since there are S incoming V-vectors, there will be S outgoing dot-product scalars. In one example embodiment, integer precision is increased throughout the tree, culminating in, for example, 25-bit integer precision, to avoid any loss of data. In general, each member of the intermediate vector has the maximum value subtracted, meaning that results of this subtraction are either zero or negative. At this point, the 25-bit integer value is converted, in a non-limiting example, to a 16-bit floating point value, including a divide-by-sqrt(M) operation (typically dividing by eight, implemented as a shift-right by three bits) inherent in the compute algorithm and, potentially, right-bit-shifts or left-bit-shifts to provide flexibility for scaling the intermediate vector by an additional factor, such as up by 2× or 4× or down by 2× or 4×, before insertion into the EXP( ) operation.

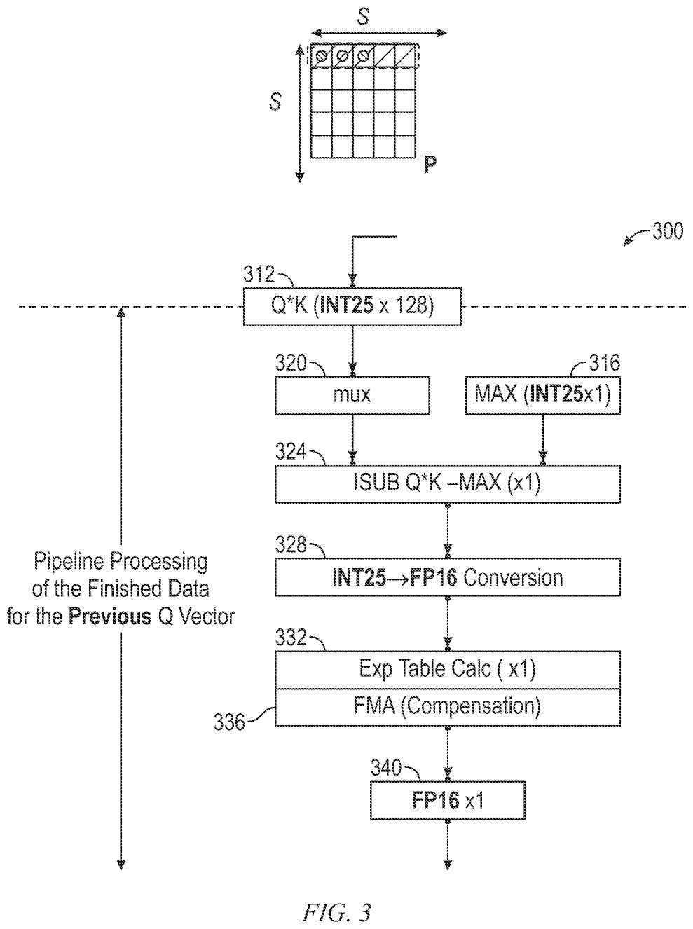

FIG. 3 thus illustrates a block diagram of a softmax stage 300 (stage 2) that processes the intermediate vector of length S produced by the K-Q stage 222, in accordance with an example embodiment. (One “attention head” is responsible for 128 incoming ten-bit integer elements, in a non-limiting example.) The top matrix of FIG. 3 illustrates that the softmax compute is performed along one row of the P matrix 212. The softmax(K*Q[s]) is normally defined as:

$$\frac{{e}^{K * Q [ s ]}}{\sum {e}^{K * Q [ s ]}}$$

There are, however, inefficiencies in complex operations, such as softmax in self-attention. In one or more exemplary embodiments, the softmax e K*Q[s] is instead partially defined as:

$${e}^{K * Q [ s ] - MAX ( K * Q [ s ] )}$$

In the latter case, the denominator computation and the division by the denominator is performed at a later stage (i.e., at stage 3 and 4, respectively). The calculation of the denominator, Σe^{K*Q[s]-Max(K*Q[s])} is postponed and is computed in stage 3. Further, the division with Σe^{K*Q[s]-Max(K*Q[s])} is performed after the P*V matrix-multiplication operation in stage 4. Note that, instead of computing P as

$$\frac{{e}^{K * Q [ s ]}}{\sum {e}^{K * Q [ s ]}}$$

and then computing P*V, a matrix P′ is computed as e^{K*Q[s]-MAX(K*Q[s])}, followed by a matrix multiplication P′*V and, subsequently, the division operation is performed to yield P′*V/Σ e^{K*Q[s]-Max(K*Q[s])}. In essence, P′*V/Σe^{K*Q[s]-Max(K*Q[s])}=(P′/Σe^{K*Q[s]-Max(K*Q[s])})*V=P*V Note that e^{K*Q[s]-Max(K*Q[s])}/Σe^{K*Q[s]-Max(K*Q[s])}=e^{K*Q[s]}/Σe^{K*Q[s]}. In summary, one or more embodiments compute softmax by performing the division operation after the P*V computation, but the result is the same. In essence, MAX(K*Q [s]) is subtracted first, where the inputs to EXP( ) are≤0 and the outputs from EXP( ) run only from 0.0 to 1.0. This is performed using the same storage buffer into which new results are soon to be deposited for the next Q vector. The phase difference between this stage and the K-Q stage 222 allows the read-pointer from this buffer to stay “just ahead” of the write pointer overwriting old-data with new-data for the next Q-vector. (It is noted that the computation of the sum and denominator are delayed to a later stage in one or more embodiments.)

In one example embodiment, the contents of the Q*K register 256 are transferred to the Q*K register 312 of the second stage of the pipeline and the contents of the max register 264 are transferred to the max register 316 of the second stage of the pipeline. In a non-limiting example, the precision of the Q*K register 256 and the max register 264 is 25-bits integer. The value K*Q [s]−MAX(K*Q [s]) is then computed by Q*K-max unit 324 for each element of the given row of the P matrix 212 that resides in the Q*K register 312. In particular, the multiplexer 320 selects one of the elements of the given row of the P matrix 212 that resides in the Q*K register 312 and inputs it to the Q*K-max unit 324. The Q*K-max unit 324 also accesses the maximum value that corresponds to the given row of the P matrix 212 and that resides in the max register 316. In a non-limiting example, the precision of the value K*Q[s]−MAX(K*Q[s]) operation is 25 bits integer.

As each K*Q[s]−MAX(K*Q[s]) value is computed, the result is converted by converter 328 from a 25-bit integer to a floating point value. In a non-limiting example, the precision of the floating point value K*Q[s]−MAX(K*Q[s]) is 16 bits. The result, which is used in the computation e^{K*Q[s]-MAX(K*Q[s])} below, ensures that the exponent has a value between 0 and 1.

The floating point value is input to an exponential look-up table, facilitated by exponential calculator 332, to look-up slope and offset values that are used to compute e^{K*Q[s]-MAX(K*Q[s])} In essence, the result e^{K*Q[s]-MAX(K*Q[s])} is derived by calculating slope*x+offset, where x is the floating point value that is input to the exponential calculator 332 and the fused multiply-add (FMA) unit 336. The result is stored in a floating point register 340. In a non-limiting example, the precision of the exponential calculator 332 is 16 bits. As there are S elements in the Q*K register 312, the exponential calculator 332 produces S values over S steps.

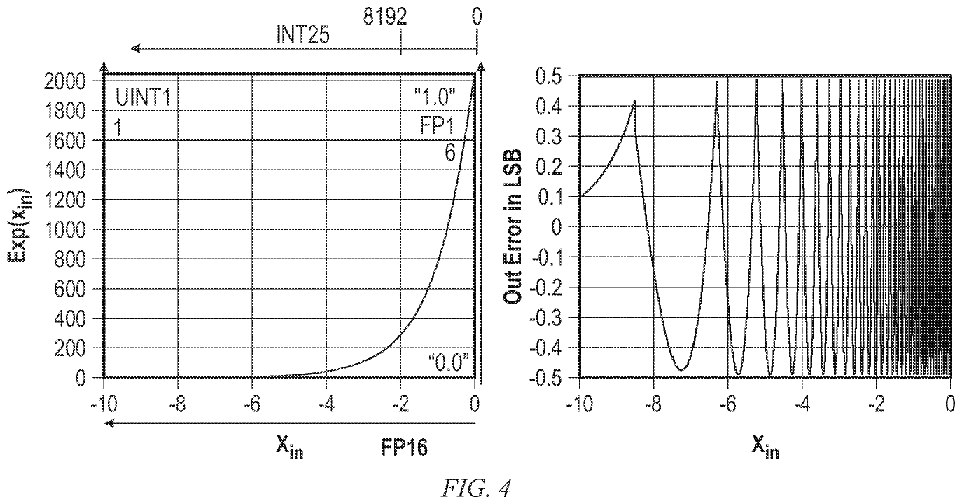

As noted above, the EXP( ) operation is performed using a look-up table accessed by the exponential calculator 332. FIG. 4 illustrates a graph of the exponential function implemented by the exponential calculator 332 and the FMA unit 336, in accordance with an example embodiment. The function is divided into a plurality of segments, or bins, along the x-axis. The incoming x value is compared in parallel against a plurality of bin-edge locations to identify “which bin” of the exponential function that the x value sits in. The function of each bin is estimated by a straight line, the slope and offset value of which are retrieved from the look-up table. The estimate for EXP( ) is then computed as SLOPE*x+OFFSET using the fused multiply-add (FMA) unit 336. The output of the EXP( ) operation is used, in a non-limiting example, in both the 16-bit floating point form (aggregation in preparation for the normalization) and in an 11-bit unsigned integer form (for a subsequent multiplication against the vector V to take place in stage 3).

Because the range of possible 16-bit floating point outputs for the pexp value (the result of the EXP( ) operation) is constrained to the range of 0.000 to 1.000, it becomes possible to perform the subsequent 11-bit unsigned integer operation without having to actually perform a full 11-bit multiply. Instead, the multiplier can process only the lower-order 9-bits of pexp, and then adjust for the edge cases with simple logic based only on the high-order 2 bits of pexp. This allows the integer multiply-add (IMA) unit to be much smaller—there would be a significant cost to supporting an 11-bit unsigned integer multiplied by 10-bit SM10 (that is, one sign bit and nine bits for magnitude).

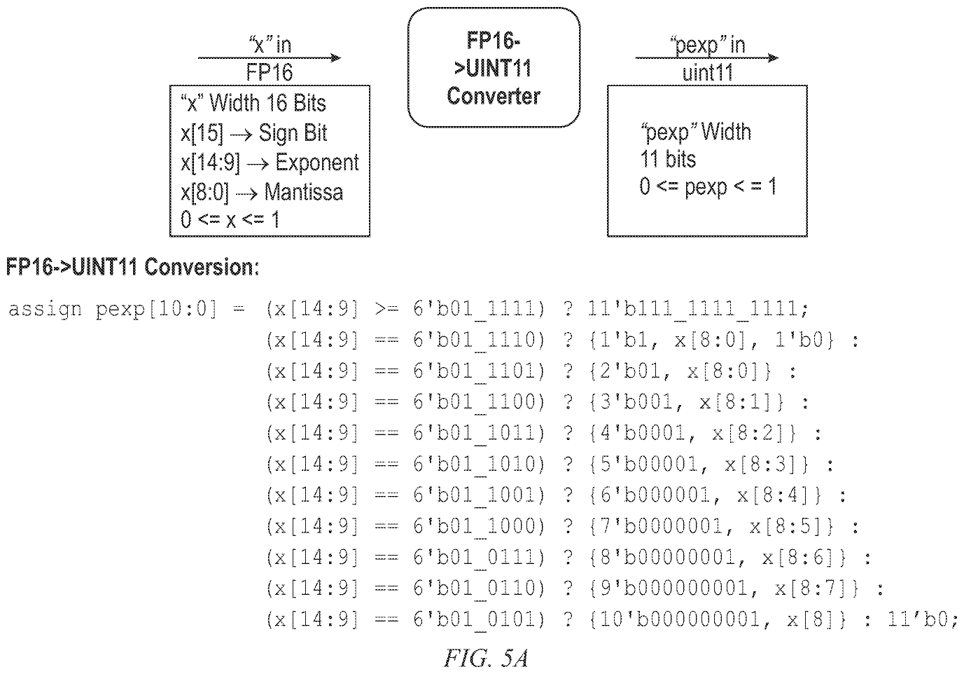

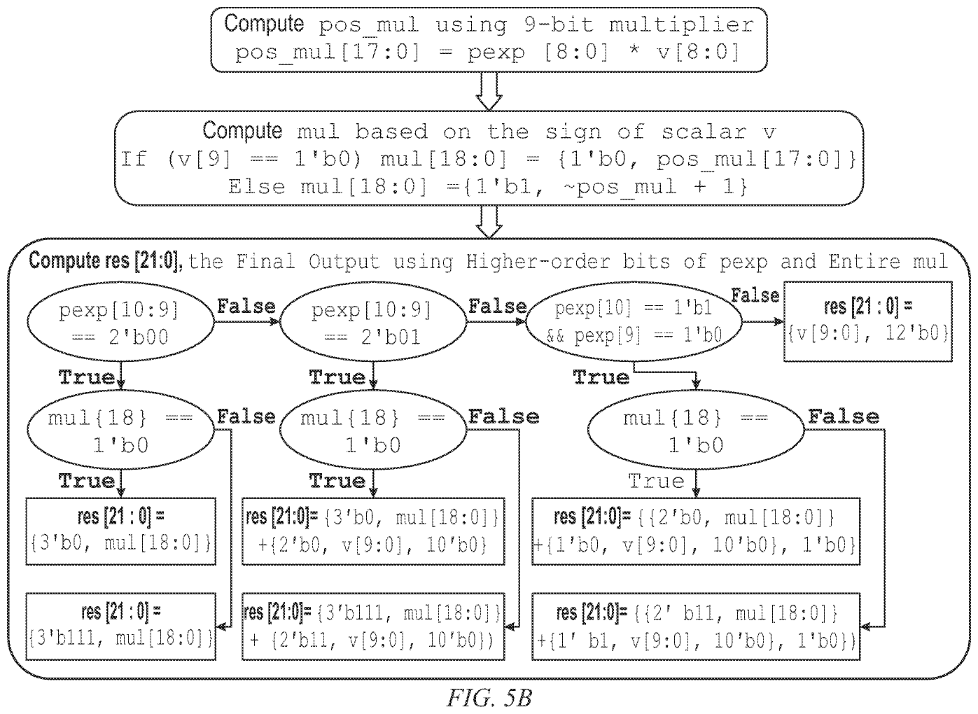

FIGS. 5A-5B illustrate a technique for performing an eleven-bit by ten-bit multiplication using a nine-bit by ten-bit multiplier, in accordance with an example embodiment. In one example embodiment, a 16-bit floating point (FP16) number to 11-bit unsigned integer (UINT11) conversion expression is used to perform an eleven-bit by ten-bit multiplication using a nine-bit by ten-bit multiplier. In the conversion expression, x is a 16-bit wide scalar in the FP16 format, x[15] is the 15^{th} bit representing the sign-bit (since 0≤x≤1, the sign bit (i.e., x[15]) is ignored), and x[14: 9] represents six bits of the exponent (which signifies the amount of right shifting to be performed on the mantissa bits (i.e., x[8: 0])). For example, if x[14: 9]>=6′b01_1110, then pexp[10: 0]={1′b1,x[8: 0], 1′b0}, meaning (10^{th} bit) pexp[10]=1, pexp[9: 1]=x[8: 0], and (the 0^{th} bit pexp[0])=0, thus forming an 11-bit wide pexp scalar.

In one example embodiment, a standard multiplication of an eleven-bit unsigned integer and a ten-bit quantity (with one sign bit and nine bits for magnitude) is defined as:

```
pos_res[19:0] = pexp[10:0] * v[8:0]
if (v[9] == 1′b0)
  res[20:0]={1′b0, pos_res}
else
  res[20:0]={{1′b1, ~pos_res + 1}
```

In the above operation, pexp[10: 0] is the first operand in UINT11 format, v[9: 0] is the second operand in SM10 format, and res[20: 0] is the output of UINT11*SM10 multiplication operation. Since the range of possible FP16 outputs for the pexp value is constrained to the range 0.000 to 1.000, it becomes possible to perform the next UINT11 operation without having to perform a full 11-bit multiply. Instead, the multiplier can process only the lower-order 9-bits of pexp, and then adjust for the edge cases with simple logic based on only the high-order 2 bits of pexp. This allows the IMA to be much smaller in comparison to the significant cost to support UINT11*SIM10.

FIG. 5B describes the UINT11*SM10 multiplication operation realized as a UNIT9*SM10 multiplication, as will be apparent to the skilled artisan based on the terminology herein and the description of FIG. 5A.

Stage 3: P-V stage

Referring now again to FIG. 3, stage 3 of the pipeline, the P-V stage 300, multiplies the P matrix 212 by the V matrix 216. This matrix-multiplication is performed by accessing each V vector from a V SRAM 228, one per clock-cycle, using a pipelined hierarchical multiply-add tree, with the entrance layer performing parallel multiplies, and then layers (using a 16, 4, and 2 integer add (IADD) unit) performing operations until the final dot-product sum is obtained. In a non-limiting example, 64 parallel multiplies are performed on ten-bit integers.

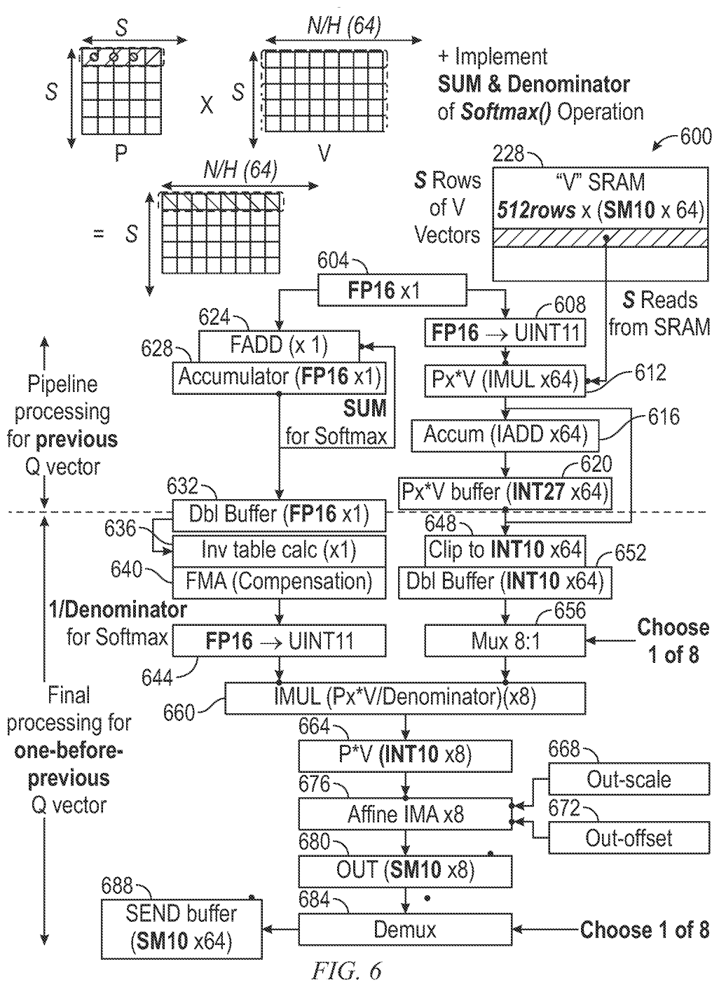

FIG. 6 illustrates a block diagram of a P-V stage 600 (stage 3) that sequentially processes S intermediate values from the softmax stage 300, in accordance with an example embodiment. These represent the numerator values for each element in one-row vector of the P matrix 212 shown earlier. (The denominator is applied later.) Each member of this intermediate vector is injected into an aggregate unit to prepare the denominator value (in 16-bit floating point form, in a non-limiting example). Since this aggregation will be over all S values of the vector, additional mantissa bits should be allocated within the accumulator in order to avoid rounding errors on the least significant bit (LSB) of the mantissa.

In addition, each output from the EXP( ) unit is multiplied against every member of the associated V vector (in 11-bit unsigned integer form, with V as SM10 quantities). Summation of the resulting P[s]*V vector is performed in parallel across the 64 elements of V, across all S, in order to implement the vector-matrix multiplication. Summation is performed using, in a non-limiting example, 27-bit integer form so as to avoid any data-loss during summation.

Once the S values coming out of the EXP( ) block have arrived, the aggregated sum of all EXP( ) operations is transferred to a double-buffer so that the incoming EXP( ) values for the NEXT Q-vector can start processing. Similarly, the final P*V vector is transferred into an output double-buffer, with data-reduction from 27-bit integer down to, in a non-limiting example, 10-bit integer form after a 13-bit right-shift, so that the P*V summation buffer can be cleared for processing of data for the next Q vector. This implies that nine bits plus sign are kept, with four bits lost on the most significant bit side, and 13 bits lost on the least significant bit side.

In one example embodiment, the rows of the output O matrix 220 are computed one by one. Each row takes S steps to compute. A given row of the P matrix 212 is accessed to compute a given row of the O matrix 220. For each row of the P matrix 212, element i of the P matrix 212, for i=1 to S, is accessed, multiplied by a corresponding element in column i of the V matrix 216 by P*V multiplier 612, the result is added by accumulator 616 to the value stored in the PV buffer 620, and the result is stored in the PV buffer 620. (In a non-limiting example, the P*V multiplier 612 includes 64 multiplication units, the accumulator 616 includes 64 summation units, and the PV buffer 620 supports 64 accumulation results at a 27-bit integer precision.) Thus, during the second iteration, the second element of the first row of the P matrix 212 is accessed, multiplied by a corresponding element in the second column of the V matrix 216 by P*V multiplier 612, the result is added by accumulator 616 to the value stored in the PV buffer 620, and the result is stored in the PV buffer 620. Once all S elements of the first row of the P matrix 212 have been processed, the PV buffer 620 will contain the first row of the O matrix 220 and is passed to stage 4 of the pipeline. By repeating this technique for each row of the matrix P 212, the entire O matrix 220 can be computed. It is noted that, prior to performance of the multiply operation by P*V multiplier 612, the 16-bit floating point value in the FP16 register 604 is converted, in a non-limiting example, to an 11-bit integer by converter 608. Also, the accumulated values (for one row of the O matrix 220) are temporarily stored in P*V buffer 620 as the accumulation occurs.

In addition, as noted above, the value Σe^{K*Q[s]-Max(K*Q[s])} typically needs to be computed. In one or more embodiments, this is accomplished by adding, using an adder 624, each 16-bit floating point value in the FP16 register 604 to an accumulation register 628. The result is a summation of the contents of all elements in one row of the P matrix 212. The result is transferred to the next stage of the pipeline via a double buffer 632.

### Stage 4: Final Stage

The final stage of the pipeline involves the scaling of output data. At this point, a double-buffer (double buffer 632) holds the aggregated-sum of EXP( ) in a 16-bit floating point format, and a double-buffer (P*V buffer 620) of width 64 holds the summed P*V data. The aggregated-sum is put through an INV( ) look-up table in a similar manner to the EXP( ) operation performed by the exponential calculator 332 and the FMA unit 336. The incoming x value is compared in parallel against all bin-edge locations to identify “which bin” the x value sits in. The appropriate slope and offset value are retrieved for that particular bin (of the INV( ) function). The estimate for EXP( ) is computed as SLOPE*x+OFFSET using a 16-bit floating point fused multiply-add (FMA) unit 640. The output of the INV( ) operation is used in 11-bit unsigned integer form (for a subsequent multiplication against the vector P*V) as described earlier, in order to support implementation with a 9-bit unsigned integer times a 10-bit integer multiplier. This effectively divides the long-delayed denominator associated with the softmax operation. In a non-limiting example, these operations are performed with 8-wide multipliers, with time-multiplexing over 8 clock-cycles providing pipelined execution across all 64 members of the P*V vector. Using a similar execution-width of 8, affine out-scaling with scalar (single) scale and offset values is performed, including appropriate right-shift down to SM10 output.

Note that one or more embodiments are computing Σe^{K*Q[s]-Max(K*Q[s]} (604 contains e^{K*Q[s]-Max(K*Q[s]})). Further, note that e^{K*Q[s]-Max(K*Q[s]})/Σe^{K*Q[s]-Max(K*Q[s]})=^{eK*Q[s]}/Σe^{K*Q[s]}

To produce the softmax result

$$\frac{\sum {e}^{K * Q [ s ] - MAX ( K * Q [ s ] )}}{\sum {e}^{K * Q [ s ] - MAX ( K * Q [ s ] )}} ,$$

the value

$$\frac{1}{\sum {e}^{K * Q [ s ] - MAX ( K * Q [ s ] )}}$$

is computed and multiplied by e^{K*Q[s]-MAX(K*Q[s])} To compute

$$\frac{1}{\sum {e}^{K * Q [ s ] - MAX ( K * Q [ s ] )}} ,$$

the contents of the double buffer 632 is input to an inversion table calculator 636 with FMA compensator 640 in a similar manner to the exponential calculator 332 and the FMA compensation unit 336. In a non-limiting example, the value

$$\frac{1}{\sum {e}^{K * Q [ s ] - MAX ( K * Q [ s ] )}}$$

is then converted from a 16-bit floating point to an 11-bit integer by converter 644 prior to multiplication by multiplier 660.

In parallel, one row of the O matrix 220 is obtained from the P*V buffer 620 and each value in the row is clipped, in parallel, to a ten-bit integer by the clipper 648 (which includes, in a non-limiting example, 64 multiplication units). The result is stored in double buffer 652. A multiplexer 656 selects one of the elements of the row of the O matrix 220 from the double buffer 652 and inputs it to a multiplier 660 for multiplication with the output of the converter 644. The result is stored in P*V register 664. In a non-limiting example, the multiplier 660 includes eight multiplication units and, thus, eight steps are needed to generate the 64 elements of the row of the O matrix 220.

In one example embodiment, an affine scaling function (alpha*x+beta) is applied for error correction by an affine unit 676, based on out-scale and out-offset parameters obtained from an out-scale register 668 and an out-offset register 672, respectively. The result of the affine scaling is stored in out register 680, and then stored into a corresponding location of a send buffer 688 via a demultiplexer 684.

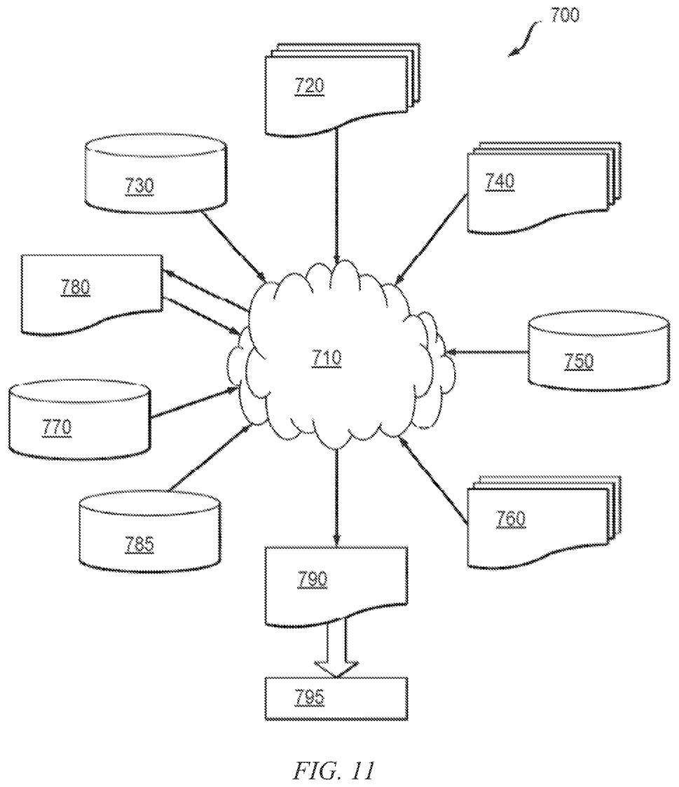

Given the teachings herein, the skilled artisan will be able to implement the elements of the K-Q stage 222, the softmax stage 300, the P-V stage 600, and the final stage of FIGS. 2, 3, and 6 using logic gates and circuitry, memory devices and circuitry, other digital electronic circuitry, or any combination of the above. For example, digital logic circuitry and other digital electronic circuitry can be synthesized, based on the descriptions herein, using a procedure as described below with respect to FIG. 11 and accompanying text.

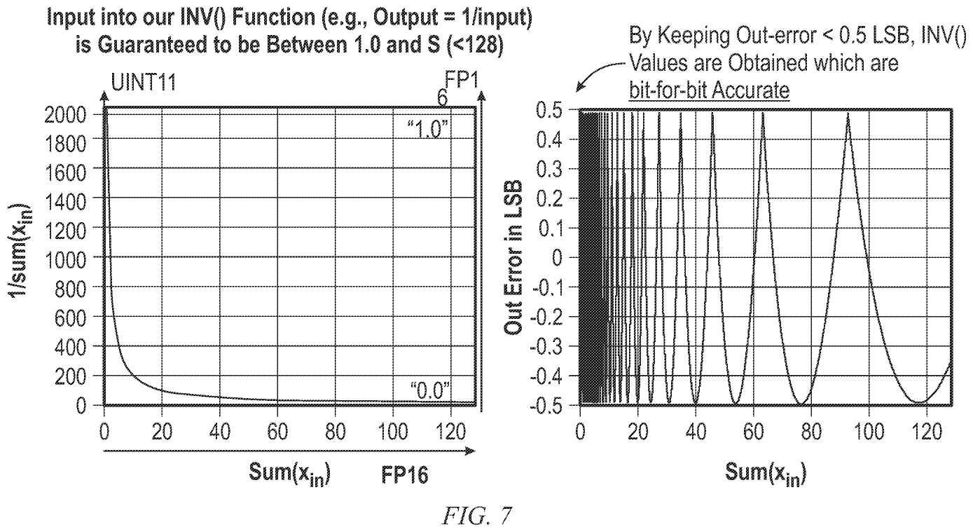

FIG. 7 illustrates graphs utilized in implementing the inversion table calculator 636 with FMA compensator 640, in accordance with an example embodiment. The exponential function (left graph) is divided into an arbitrary number of bins defined by the vertical lines. In the non-limiting example of FIG. 7, there are seven bins. The segment of the exponential function of each bin is estimated by a slope and offset. As noted above, the result of the inversion is determined by calculating SLOPE*x+OFFSET. The graph on the right is an error plot. It shows the error for each value of x (i.e., plotted on the x axis) incurred using the disclosed method of computing the INV( ) function. As shown, the errors are within 0.5 LSB (out-error<0.5 LSB), leading to INV( ) values which are bit-for-bit accurate.

### Higher-level Parallelism

In one example embodiment, an attention-compute workload is partitioned and distributed to a plurality of compute engines and multiple vectors of the O matrix 220 are computed in parallel using the plurality of compute engines, where the O matrix 220 corresponds to a head's worth of computations (such as, softmax(Q₁*K₁^{T})*V₁). The sequence length dimension of the Q matrix 204 is partitioned and the K matrix 208 and the V matrix 216 are replicated such that each computation engine receives a fraction of the Q matrix 204 and computes a fraction of output O matrix 220.

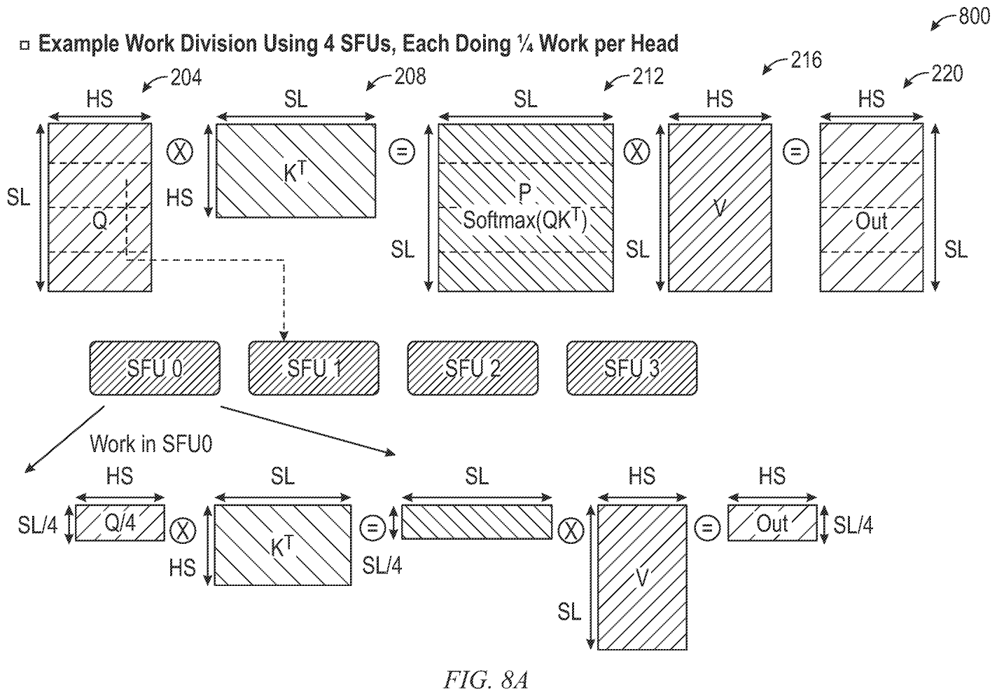

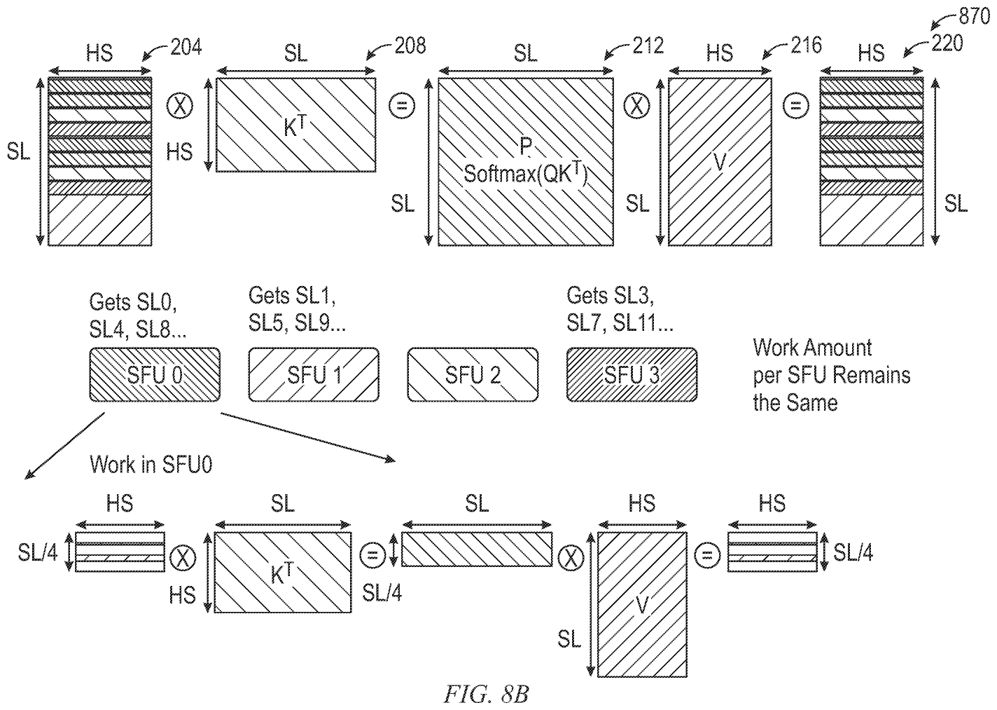

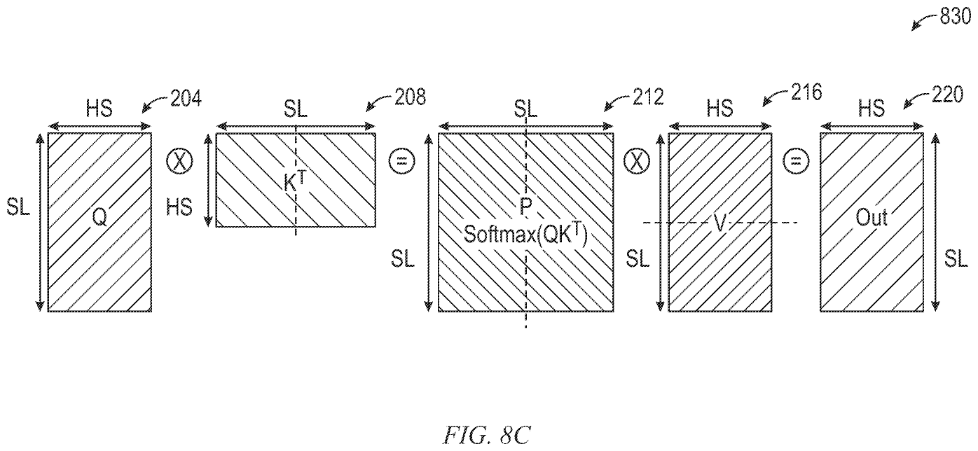

FIG. 8A is a block diagram of a first parallel implementation 800 utilizing a plurality of compute engines, in accordance with an example embodiment. The parallel implementation 800 divides a workload over, for example, four instances of the compute engine. Since the Q matrix 204 is processed on a row-by-row basis, the workload is divided by segmenting the Q matrix 204 into sets of contiguous rows, such as, for example, four sets, as depicted in FIG. 8A. It is noted that the K matrix and the V matrix are replicated across four instances of the compute engine (i.e., one copy per compute instance) and that different rows of the P matrix are generated (computed) across the four instances of the compute engine. Further, each instance produces 1/4 of the total rows (in a non-limiting example). In addition, different rows of the O matrix are generated (computed) across the four instances of the compute engine. Thus, each instance is producing 1 of the total rows (in a non-limiting example).

FIG. 8B is a block diagram of a second parallel implementation 870 utilizing the above architecture, in accordance with an example embodiment. As with the first parallel implementation 800, the parallel implementation 870 divides a workload over, for example, four instances of the compute engine. Since the Q matrix 204 is processed on a row-by-row basis and the workload is divided into sets of contiguous rows (in the example of FIG. 8A), each instance of the work engine processes the first row of its set of rows first, followed by the remaining rows in the set. Thus, in the example of FIG. 8A, the first rows of the O matrix 204 (that are completed by the four instances of the compute engine in parallel) are not contiguous; rather, the first rows produced by the compute engines are separated in the O matrix 220. This means that a downstream task would not have a set of contiguous rows of the O matrix 220 available for processing. This is satisfactory if the downstream task is similarly pipelined; that is, if the downstream task operates in parallel on non-contiguous rows. If this is not the case, processing by the downstream task would typically need to be delayed until the appropriate number of rows was available and storage would need to be provided to accumulate the rows as they are produced. To alleviate these requirements, the workload may be divided in an alternate manner, as illustrated in FIG. 8B. By allotting the first n contiguous rows of the Q matrix 204 to a corresponding instance (of n instances) of the compute engine, the first set of n contiguous rows of the O matrix 220 will be produced first, the second set of n contiguous rows of the O matrix 220 will be produced next, and so on. Thus, the downstream task will have access to n contiguous rows of the O matrix 220 when it begins processing.

FIG. 8C is a block diagram of a third parallel implementation 830 utilizing the above architecture, in accordance with an example embodiment. The parallel implementation 830 divides a workload by dividing the matrices K, P and V. This is an example of inefficient partitioning, as the row-by-row processing of the Q matrix 204 requires access to all of the data of K matrix 208 by each instance of the compute engine.

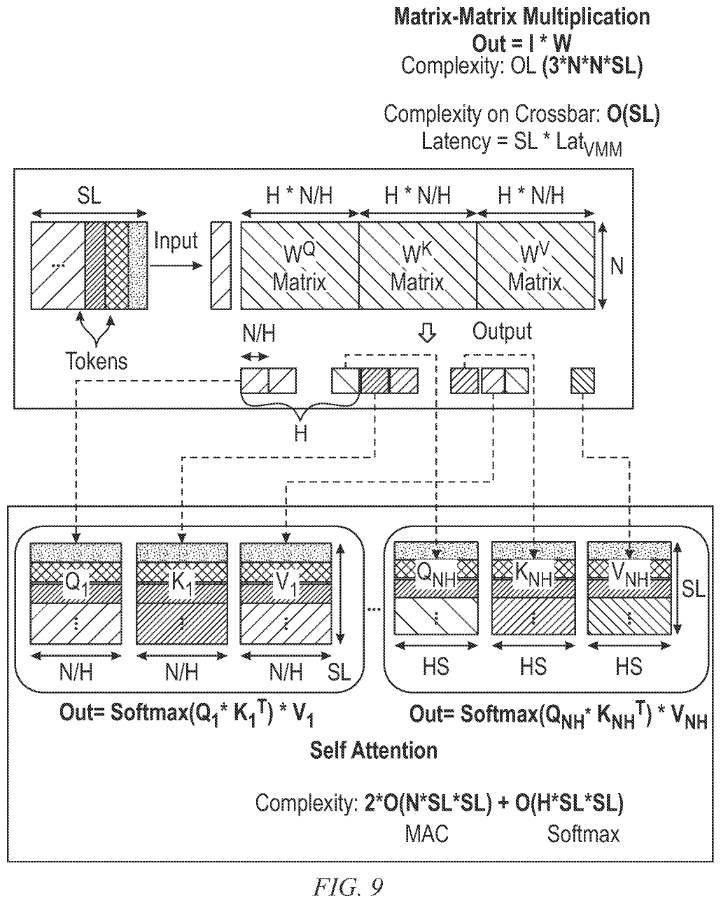

FIG. 9 illustrates the matrix architecture for a computation engine (also referred to as a special function unit herein), in accordance with an example embodiment. Vectors of the Q matrix 204 belonging to different sequence lengths are fed, one at a time (SL0, SL1, . . . ) every ‘SL’ cycles into stage 1 of the computation engine; that is, feed SL0 (the first row of the Q matrix 204) at cycle_0, SL1 (the second row of the Q matrix 204) at cycle_SL, SL2 at cycle_2*SL, and so on.

Vectors of the K matrix 208 belonging to different SLs are iteratively fed, one at a time (SL0, SL1, . . . ) every cycle into the computation engine; that is, SL0 (the first column of the K matrix 208) is fed at cycle_0, SL1 (the second column of the K matrix 208) is fed at cycle_1, SL2 (the third column of the K matrix 208) at cycle 2, and so on. After SL cycles, the two steps above are repeated.

Vectors of the V matrix 216 belonging to different SLs (SL0, SL1, . . . ) are iteratively fed every cycle into the computation engine; that is, SL0 (the first row of the V matrix 216) is fed at cycle_0, SL1 (the second row of the V matrix 216) is fed at cycle_1, SL2 (the third row of the V matrix 216) at cycle 2, and so on. After SL cycles, the above step is repeated. The first row vector of the O matrix 220 is produced after at least SL*SL cycles. After the first valid vector is generated, a valid output vector is output every other cycle.

In a non-limiting example, one “attention head” is responsible for 128 incoming 10-bit integer elements. These stages can operate in a pipeline parallel fashion, with the vectors associated with each Q-value moving through the stages of the compute-engine. After some initial delay, the output data is available for transmission to a downstream task (for instance, to an analog-AI tile for efficient implementation of the out-projection, fully-connected layer). Once this occurs, each loop of size S—through the K vectors in stage 1, through the resulting P values and V vectors in stages 2 and 3, and in scaling the final P*V output by the softmax( ) denominator and affine-outscale coefficients in stage 4—can take place in parallel. Load Q, cycle through all K's, load Q, cycle through all K's. Then, obtain O's after some delay.

### Applications

In one example embodiment, the self-attention computation results are used in natural language processing (NLP), vision processing and the like. The integration of the disclosed self-attention techniques improve the speed of computation and reduces the consumed power of the self-attention computation.

Given the discussion thus far, it will be appreciated that, in general terms, an exemplary method, according to an aspect of the invention, includes the operations of pushing a given row vector of a first matrix 204; pushing a column vector of a second matrix 208 on each of a plurality of clock cycles; and pushing a column vector of a third matrix 212 on each of the plurality of clock cycles after a given delay.

In one aspect, a method for performing self-attention computations by delaying performance of a division operation of a softmax computations includes the operations of iteratively computing a first matrix multiplication of a given row vector of a first matrix 204 and each column vector of a second matrix 208 while determining a first scalar element representing a maximum value of the iterative first matrix multiplications; iteratively subtracting a corresponding determined first scaler element from a result of each computed first matrix multiplication and computing an elementwise exponential function based on a result of the subtraction operation to generate a plurality of elements of a given row vector of a fourth matrix 212; iteratively computing a second matrix multiplication of a given row vector of the fourth matrix 212 and each column vector of a third matrix 216 while summing the given row vectors of the fourth matrix 212 to obtain a second scalar; and computing a row vector of an output matrix 220 based on results of the second matrix multiplications.

In one aspect, an apparatus comprises a compute engine configured to perform self-attention computations by delaying performance of a division operation of a softmax computation, the performance of the self-attention computations including iteratively computing a first matrix multiplication of a given row vector of a first matrix 204 and each column vector of a second matrix 208 while determining a first scalar element representing a maximum value of the iterative first matrix multiplications; iteratively subtracting a corresponding determined first scaler element from a result of each computed first matrix multiplication and computing an elementwise exponential function based on a result of the subtraction operation to generate a plurality of elements of a given row vector of a fourth matrix 212; iteratively computing a second matrix multiplication of a given row vector of the fourth matrix 212 and each column vector of a third matrix 216 while summing the given row vectors of the fourth matrix 212 to obtain a second scalar; and computing a row vector of an output matrix 220 based on results of the second matrix multiplications.

In one example embodiment, the compute engine includes a first pipeline stage 222 configured to perform the first matrix multiplication; a first memory device 224 coupled to the first pipeline stage 222 and configured to store the first matrix 204 and the second matrix 208 and to provide a different vector of the second matrix 208 on each of a plurality of consecutive clock cycles; and a second memory device 228 coupled to the first pipeline stage 222 and configured to store the third matrix 216 and provide a different vector of the third matrix 216 on each of the plurality of consecutive clock cycles.

In one example embodiment, the compute engine includes a first memory device 224 coupled to a first pipeline stage 222 and configured to store the first matrix 204 and the second matrix 208; a second memory device 228 coupled to the first pipeline stage 222 and configured to store the third matrix 216; the first pipeline stage 222 being configured to perform the first matrix multiplication, wherein each of the first matrix 204 and the second matrix 208 comprises a plurality of row vectors and a plurality of column vectors, wherein each row vector and each column vector comprises one or more data elements, and wherein the first pipeline stage 222 is configured to read the given row vector of the first matrix 204, iteratively read each column vector of the second matrix 208, compute the plurality of first matrix multiplication operations between the given row vector of the first matrix 204 and each of the column vector of the second matrix 208, and compute the first scalar element representing the maximum value

In one example embodiment, the first memory device 224 is a dual-port memory device.

In one example embodiment, the first memory device 224 further comprises two single-port memory devices.

In one example embodiment, the compute engine includes a second pipeline stage configured to calculate the given row vector of the fourth matrix 212 by subtracting the first scalar element from each result of the first matrix multiplication; and compute the elementwise exponential function of each element of the given row vector of the fourth matrix 212.

In one example embodiment, the compute engine includes a third pipeline stage 600 configured to perform the second matrix multiplication operation, wherein each of the third matrix 216 and the fourth matrix 212 comprises a plurality of row vectors and a plurality of column vectors, wherein each row vector and column vector of the third matrix 216 and the fourth matrix 212 comprises one or more data elements, and wherein the third pipeline stage is further configured to read the given row vector of the fourth matrix 212, iteratively read each data element of the given row vector of the fourth matrix 212 and a row vector of the third matrix 216, compute an initial output row vector representing the plurality of second matrix multiplication operations between data elements of the given row vector of the fourth matrix 212 and row vectors the third matrix 216; and compute a sum of given row vectors of the fourth matrix 212 to obtain a second scalar.

In one example embodiment, the compute engine includes a fourth pipeline stage configured to compute an inversion of the second scalar to obtain a third scalar; and compute a fifth row vector by multiplying each data element of the (initial) row vector of the output matrix 220 based on results of the second matrix multiplications with the third scalar, wherein the fifth row vector represents a final given row of a fifth matrix 220.

In one example embodiment, the compute engine is configured to scale each data element of the fifth vector and offset the scaled data element by multiplying with a first constant and adding a result of the multiplication with the first constant with a second constant.

In one example embodiment, the self-attention compute is defined as softmax(Q_{NH}*K_{NH}^{T}/\sqrt{dk})*V_{NH}.

In one example embodiment, the apparatus further includes one or more additional compute engines, wherein the apparatus is configured to partition a sequence length dimension of the first matrix 204 among the compute engines and replicate the second matrix 208 and the third matrix 212 for each compute engine, and wherein each of the plurality of compute engines is configured to compute a fraction of the output matrix 220.

In one example embodiment, the fraction of the first matrix 204 received by each compute engine comprises rows identified by (a+n*i) where n is a count of the compute engines, i ranges from 0 to K/n and a is a unique number assigned to each compute engine, where a is between 1 and n, and where K is a total number of rows in the first matrix 204. Furthermore, “i” is associated with rows of the Q matrix and its range is 0 to K/n, where K is the number of rows in the Q matrix (also referred to as sequence length).

In one example embodiment, the compute engine further includes a look-up table and wherein each elementwise exponential function is computed by segmenting the elementwise exponential function into a plurality of bins, wherein each bin corresponds to a specified range of an input variable x of the elementwise exponential function; determining a bin of the plurality of bins that corresponds to the input variable x and performing a table look-up to retrieve a slope and an offset for the determined bin, wherein the slope identifies a slope of a piece-wise linear approximation of the elementwise exponential function over the specified range of the determined bin and the offset; and computing slope*x+offset to approximate the elementwise exponential function exp(x).

In one example embodiment, each element of the computed row vector of the output matrix 220 is iteratively divided by the corresponding determined second scalar.

Note that in one or more embodiments, the apparatus is configured with reduced-precision components to ensure energy efficiency while maintaining neural network accuracy.

It is noted that the skilled artisan can derive the slopes and corresponding offsets for the lookup table, given the teachings in the specification. For example, the slope and offset values for each bin, and the number of bins, are selected to minimize errors due to piece-wise linear approximation. The number of bins and look-up table can be configurable or can be pre-defined prior to manufacture; the lookup table can be populated with slope and offset values prior to manufacture or on-the-fly. The truth table can be configurable and it content (i.e., slope and offset) can be (re-)programmed multiple times. It can also be hardwired during manufacturing (i.e., making it non programmable). Generally, other methods for computing slope and offset can be employed; for example, it could be a formula, or it could be done by manual trial and error method. Note that the first, second, third, and fourth pipeline stages are numbered for convenience but can be employed stand-alone, all together, or in various combinations; thus, for example, for a claim directed to a “fourth” pipeline stage, first, second, and third pipeline stages could, but need not, be present.

Computing Device Useful in Connection with Exemplary Design Process Used in Semiconductor Design, Manufacture, and/or Test

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Computing environment 2100 contains an example of an environment for the execution of at least some of the computer code involved in performing the inventive methods, such as a design-to-lithography tool 2200. In addition to block 2200, computing environment 2100 includes, for example, computer 2101, wide area network (WAN) 2102, end user device (EUD) 2103, remote server 2104, public cloud 2105, and private cloud 2106. In this embodiment, computer 2101 includes processor set 2110 (including processing circuitry 2120 and cache 2121), communication fabric 2111, volatile memory 2112, persistent storage 2113 (including operating system 2122 and block 2200, as identified above), peripheral device set 2114 (including user interface (UI) device set 2123, storage 2124, and Internet of Things (IoT) sensor set 2125), and network module 2115. Remote server 2104 includes remote database 2130. Public cloud 2105 includes gateway 2140, cloud orchestration module 2141, host physical machine set 2142, virtual machine set 2143, and container set 2144.

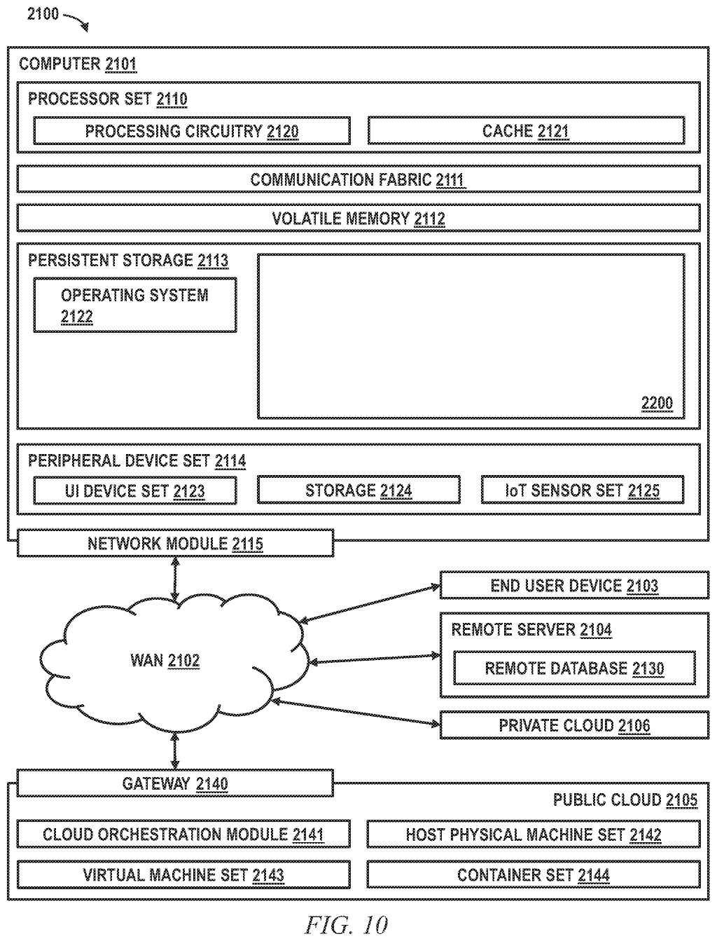

COMPUTER 2101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 2130. As is well understood in the art of computer technology, and depending upon the technology, performance of a computer-implemented method may be distributed among multiple computers and/or between multiple locations. On the other hand, in this presentation of computing environment 2100, detailed discussion is focused on a single computer, specifically computer 2101, to keep the presentation as simple as possible. Computer 2101 may be located in a cloud, even though it is not shown in a cloud in FIG. 10. On the other hand, computer 2101 is not required to be in a cloud except to any extent as may be affirmatively indicated.

PROCESSOR SET 2110 includes one, or more, computer processors of any type now known or to be developed in the future. Processing circuitry 2120 may be distributed over multiple packages, for example, multiple, coordinated integrated circuit chips. Processing circuitry 2120 may implement multiple processor threads and/or multiple processor cores. Cache 2121 is memory that is located in the processor chip package(s) and is typically used for data or code that should be available for rapid access by the threads or cores running on processor set 2110. Cache memories are typically organized into multiple levels depending upon relative proximity to the processing circuitry. Alternatively, some, or all, of the cache for the processor set may be located “off chip.” In some computing environments, processor set 2110 may be designed for working with qubits and performing quantum computing.

Computer readable program instructions are typically loaded onto computer 2101 to cause a series of operational steps to be performed by processor set 2110 of computer 2101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 2121 and the other storage media discussed below. The program instructions, and associated data, are accessed by processor set 2110 to control and direct performance of the inventive methods. In computing environment 2100, at least some of the instructions for performing the inventive methods may be stored in block 2200 in persistent storage 2113.

COMMUNICATION FABRIC 2111 is the signal conduction path that allows the various components of computer 2101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 2112 is any type of volatile memory now known or to be developed in the future. Examples include dynamic type random access memory (RAM) or static type RAM. Typically, volatile memory 2112 is characterized by random access, but this is not required unless affirmatively indicated. In computer 2101, the volatile memory 2112 is located in a single package and is internal to computer 2101, but, alternatively or additionally, the volatile memory may be distributed over multiple packages and/or located externally with respect to computer 2101.

PERSISTENT STORAGE 2113 is any form of non-volatile storage for computers that is now known or to be developed in the future. The non-volatility of this storage means that the stored data is maintained regardless of whether power is being supplied to computer 2101 and/or directly to persistent storage 2113. Persistent storage 2113 may be a read only memory (ROM), but typically at least a portion of the persistent storage allows writing of data, deletion of data and re-writing of data. Some familiar forms of persistent storage include magnetic disks and solid state storage devices. Operating system 2122 may take several forms, such as various known proprietary operating systems or open source Portable Operating System Interface-type operating systems that employ a kernel. The code included in block 2200 typically includes at least some of the computer code involved in performing the inventive methods.

PERIPHERAL DEVICE SET 2114 includes the set of peripheral devices of computer 2101. Data communication connections between the peripheral devices and the other components of computer 2101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 2123 may include components such as a display screen, speaker, microphone, wearable devices (such as goggles and smart watches), keyboard, mouse, printer, touchpad, game controllers, and haptic devices. Storage 2124 is external storage, such as an external hard drive, or insertable storage, such as an SD card. Storage 2124 may be persistent and/or volatile. In some embodiments, storage 2124 may take the form of a quantum computing storage device for storing data in the form of qubits. In embodiments where computer 2101 is required to have a large amount of storage (for example, where computer 2101 locally stores and manages a large database) then this storage may be provided by peripheral storage devices designed for storing very large amounts of data, such as a storage area network (SAN) that is shared by multiple, geographically distributed computers. IoT sensor set 2125 is made up of sensors that can be used in Internet of Things applications. For example, one sensor may be a thermometer and another sensor may be a motion detector.

NETWORK MODULE 2115 is the collection of computer software, hardware, and firmware that allows computer 2101 to communicate with other computers through WAN 2102. Network module 2115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 2115 are performed on the same physical hardware device. In other embodiments (for example, embodiments that utilize software-defined networking (SDN)), the control functions and the forwarding functions of network module 2115 are performed on physically separate devices, such that the control functions manage several different network hardware devices. Computer readable program instructions for performing the inventive methods can typically be downloaded to computer 2101 from an external computer or external storage device through a network adapter card or network interface included in network module 2115.

WAN 2102 is any wide area network (for example, the internet) capable of communicating computer data over non-local distances by any technology for communicating computer data, now known or to be developed in the future. In some embodiments, the WAN 2102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 2103 is any computer system that is used and controlled by an end user (for example, a customer of an enterprise that operates computer 2101), and may take any of the forms discussed above in connection with computer 2101. EUD 2103 typically receives helpful and useful data from the operations of computer 2101. For example, in a hypothetical case where computer 2101 is designed to provide a recommendation to an end user, this recommendation would typically be communicated from network module 2115 of computer 2101 through WAN 2102 to EUD 2103. In this way, EUD 2103 can display, or otherwise present, the recommendation to an end user. In some embodiments, EUD 2103 may be a client device, such as thin client, heavy client, mainframe computer, desktop computer and so on.

REMOTE SERVER 2104 is any computer system that serves at least some data and/or functionality to computer 2101. Remote server 2104 may be controlled and used by the same entity that operates computer 2101. Remote server 2104 represents the machine(s) that collect and store helpful and useful data for use by other computers, such as computer 2101. For example, in a hypothetical case where computer 2101 is designed and programmed to provide a recommendation based on historical data, then this historical data may be provided to computer 2101 from remote database 2130 of remote server 2104.

PUBLIC CLOUD 2105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 2105 is performed by the computer hardware and/or software of cloud orchestration module 2141. The computing resources provided by public cloud 2105 are typically implemented by virtual computing environments that run on various computers making up the computers of host physical machine set 2142, which is the universe of physical computers in and/or available to public cloud 2105. The virtual computing environments (VCEs) typically take the form of virtual machines from virtual machine set 2143 and/or containers from container set 2144. It is understood that these VCEs may be stored as images and may be transferred among and between the various physical machine hosts, either as images or after instantiation of the VCE. Cloud orchestration module 2141 manages the transfer and storage of images, deploys new instantiations of VCEs and manages active instantiations of VCE deployments. Gateway 2140 is the collection of computer software, hardware, and firmware that allows public cloud 2105 to communicate through WAN 2102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 2106 is similar to public cloud 2105, except that the computing resources are only available for use by a single enterprise. While private cloud 2106 is depicted as being in communication with WAN 2102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 2105 and private cloud 2106 are both part of a larger hybrid cloud.

Exemplary Design Process Used in Semiconductor Design, Manufacture, and/or Test

One or more embodiments integrate the characterizing and simulating techniques herein with semiconductor integrated circuit design simulation, test, layout, and/or manufacture. In this regard, FIG. 11 shows a block diagram of an exemplary design flow 700 used for example, in semiconductor IC logic design, simulation, test, layout, and manufacture. Design flow 700 includes processes, machines and/or mechanisms for processing design structures or devices to generate logically or otherwise functionally equivalent representations of design structures and/or devices, such as those that can be analyzed using techniques disclosed herein or the like. The design structures processed and/or generated by design flow 700 may be encoded on machine-readable storage media to include data and/or instructions that when executed or otherwise processed on a data processing system generate a logically, structurally, mechanically, or otherwise functionally equivalent representation of hardware components, circuits, devices, or systems. Machines include, but are not limited to, any machine used in an IC design process, such as designing, manufacturing, or simulating a circuit, component, device, or system. For example, machines may include: lithography machines, machines and/or equipment for generating masks (e.g. e-beam writers), computers or equipment for simulating design structures, any apparatus used in the manufacturing or test process, or any machines for programming functionally equivalent representations of the design structures into any medium (e.g. a machine for programming a programmable gate array).

Design flow 700 may vary depending on the type of representation being designed. For example, a design flow 700 for building an application specific IC (ASIC) may differ from a design flow 700 for designing a standard component or from a design flow 700 for instantiating the design into a programmable array, for example a programmable gate array (PGA) or a field programmable gate array (FPGA) offered by Altera® Inc. or Xilinx® Inc.

FIG. 11 illustrates multiple such design structures including an input design structure 720 that is preferably processed by a design process 710. Design structure 720 may be a logical simulation design structure generated and processed by design process 710 to produce a logically equivalent functional representation of a hardware device. Design structure 720 may also or alternatively comprise data and/or program instructions that when processed by design process 710, generate a functional representation of the physical structure of a hardware device. Whether representing functional and/or structural design features, design structure 720 may be generated using electronic computer-aided design (ECAD) such as implemented by a core developer/designer. When encoded on a gate array or storage medium or the like, design structure 720 may be accessed and processed by one or more hardware and/or software modules within design process 710 to simulate or otherwise functionally represent an electronic component, circuit, electronic or logic module, apparatus, device, or system. As such, design structure 720 may comprise files or other data structures including human and/or machine-readable source code, compiled structures, and computer executable code structures that when processed by a design or simulation data processing system, functionally simulate or otherwise represent circuits or other levels of hardware logic design. Such data structures may include hardware-description language (HDL) design entities or other data structures conforming to and/or compatible with lower-level HDL design languages such as Verilog and VHDL, and/or higher level design languages such as C or C++.

Design process 710 preferably employs and incorporates hardware and/or software modules for synthesizing, translating, or otherwise processing a design/simulation functional equivalent of components, circuits, devices, or logic structures to generate a Netlist 780 which may contain design structures such as design structure 720. Netlist 780 may comprise, for example, compiled or otherwise processed data structures representing a list of wires, discrete components, logic gates, control circuits, I/O devices, models, etc. that describes the connections to other elements and circuits in an integrated circuit design. Netlist 780 may be synthesized using an iterative process in which netlist 780 is resynthesized one or more times depending on design specifications and parameters for the device. As with other design structure types described herein, netlist 780 may be recorded on a machine-readable data storage medium or programmed into a programmable gate array. The medium may be a nonvolatile storage medium such as a magnetic or optical disk drive, a programmable gate array, a compact flash, or other flash memory. Additionally, or in the alternative, the medium may be a system or cache memory, buffer space, or other suitable memory.

Design process 710 may include hardware and software modules for processing a variety of input data structure types including Netlist 780. Such data structure types may reside, for example, within library elements 730 and include a set of commonly used elements, circuits, and devices, including models, layouts, and symbolic representations, for a given manufacturing technology (e.g., different technology nodes, 32 nm, 45 nm, 90 nm, etc.). The data structure types may further include design specifications 740, characterization data 750, verification data 760, design rules 770, and test data files 785 which may include input test patterns, output test results, and other testing information. Design process 710 may further include, for example, standard mechanical design processes such as stress analysis, thermal analysis, mechanical event simulation, process simulation for operations such as casting, molding, and die press forming, etc. One of ordinary skill in the art of mechanical design can appreciate the extent of possible mechanical design tools and applications used in design process 710 without deviating from the scope and spirit of the invention. Design process 710 may also include modules for performing standard circuit design processes such as timing analysis, verification, design rule checking, place and route operations, etc. Improved latch tree synthesis can be performed as described herein.

Design process 710 employs and incorporates logic and physical design tools such as HDL compilers and simulation model build tools to process design structure 720 together with some or all of the depicted supporting data structures along with any additional mechanical design or data (if applicable), to generate a second design structure 790. Design structure 790 resides on a storage medium or programmable gate array in a data format used for the exchange of data of mechanical devices and structures (e.g. information stored in an IGES, DXF, Parasolid XT, JT, DRG, or any other suitable format for storing or rendering such mechanical design structures). Similar to design structure 720, design structure 790 preferably comprises one or more files, data structures, or other computer-encoded data or instructions that reside on data storage media and that when processed by an ECAD system generate a logically or otherwise functionally equivalent form of one or more IC designs or the like. In one embodiment, design structure 790 may comprise a compiled, executable HDL simulation model that functionally simulates the devices to be analyzed.

Design structure 790 may also employ a data format used for the exchange of layout data of integrated circuits and/or symbolic data format (e.g. information stored in a GDSII (GDS2), GL1, OASIS, map files, or any other suitable format for storing such design data structures). Design structure 790 may comprise information such as, for example, symbolic data, map files, test data files, design content files, manufacturing data, layout parameters, wires, levels of metal, vias, shapes, data for routing through the manufacturing line, and any other data required by a manufacturer or other designer/developer to produce a device or structure as described herein (e.g., lib files). Design structure 790 may then proceed to a stage 795 where, for example, design structure 790: proceeds to tape-out, is released to manufacturing, is released to a mask house, is sent to another design house, is sent back to the customer, etc.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. An apparatus comprising a compute engine configured to perform self-attention computations by delaying performance of a division operation of a softmax computation, the performance of the self-attention computations comprising:
iteratively computing a first matrix multiplication of a given row vector of a first matrix and each column vector of a second matrix while determining a first scalar element representing a maximum value of the iterative first matrix multiplications;
iteratively subtracting a corresponding determined first scaler element from a result of each computed first matrix multiplication and computing an elementwise exponential function based on a result of the subtraction operation to generate a plurality of elements of a given row vector of a fourth matrix;
iteratively computing a second matrix multiplication of a given row vector of the fourth matrix and each column vector of a third matrix while summing the given row vectors of the fourth matrix to obtain a second scalar; and
computing a row vector of an output matrix based on results of the second matrix multiplications.

2. The apparatus of claim 1, wherein the compute engine comprises:
a first pipeline stage configured to perform the first matrix multiplication;
a first memory device coupled to the first pipeline stage and configured to store the first matrix and the second matrix and to provide a different vector of the second matrix on each of a plurality of consecutive clock cycles; and
a second memory device coupled to the first pipeline stage and configured to store the third matrix and provide a different vector of the third matrix on each of the plurality of consecutive clock cycles.

3. The apparatus of claim 1, wherein the compute engine comprises:
a first memory device coupled to a first pipeline stage and configured to store the first matrix and the second matrix;
a second memory device coupled to the first pipeline stage and configured to store the third matrix;
the first pipeline stage being configured to perform the first matrix multiplication, wherein each of the first matrix and the second matrix comprises a plurality of row vectors and a plurality of column vectors, wherein each row vector and each column vector comprises one or more data elements, and wherein the first pipeline stage is configured to:
read the given row vector of the first matrix, iteratively read each column vector of the second matrix, compute the plurality of first matrix multiplication operations between the given row vector of the first matrix and each of the column vector of the second matrix, and compute the first scalar element representing the maximum value.

4. The apparatus of claim 3, wherein the first memory device is a dual-port memory device.

5. The apparatus of claim 3, wherein the first memory device further comprises two single-port memory devices.

6. The apparatus of claim 1, wherein the compute engine comprises:
a second pipeline stage configured to:
calculate the given row vector of the fourth matrix by subtracting the first scalar element from each result of the first matrix multiplication; and
compute the elementwise exponential function of each element of the given row vector of the fourth matrix.

7. The apparatus of claim 1, wherein the compute engine comprises:
a third pipeline stage configured to perform the second matrix multiplication operation, wherein each of the third matrix and the fourth matrix comprises a plurality of row vectors and a plurality of column vectors, wherein each row vector and column vector of the third matrix and the fourth matrix comprises one or more data elements, and wherein the third pipeline stage is further configured to:
read the given row vector of the fourth matrix, iteratively read each data element of the given row vector of the fourth matrix and a row vector of the third matrix, compute an initial output row vector representing the plurality of second matrix multiplication operations between data elements of the given row vector of the fourth matrix and row vectors the third matrix; and
compute a sum of given row vectors of the fourth matrix to obtain a second scalar.

8. The apparatus of claim 1, wherein the compute engine comprises:
a fourth pipeline stage configured to:
compute an inversion of the second scalar to obtain a third scalar; and
compute a fifth row vector by multiplying each data element of the row vector of the output matrix based on results of the second matrix multiplications with the third scalar, wherein the fifth row vector represents a final given row of a fifth matrix.

9. The apparatus of claim 8, wherein the compute engine is configured to scale each data element of the fifth vector and offset the scaled data element by multiplying with a first constant and adding a result of the multiplication with the first constant with a second constant.

10. The apparatus of claim 1, wherein the self-attention compute is defined as softmax(Q_{NH}*K_{NH}^{T}/\sqrt{dk})*V_{NH}.

11. The apparatus of claim 1, the apparatus further comprising one or more additional compute engines, wherein the apparatus is configured to partition a sequence length dimension of the first matrix among the compute engines and replicate the second matrix and the third matrix for each compute engine, and wherein each of the plurality of compute engines is configured to compute a fraction of the output matrix.

12. The apparatus of claim 11, wherein the fraction of the first matrix received by each compute engine comprises rows identified by (a+n*i) where n is a count of the compute engines, i ranges from 0 to K/n and a is a unique number assigned to each compute engine, where a is between 1 and n, and where K is a total number of rows in the first matrix.

13. The apparatus of claim 1, the compute engine further comprising a look-up table and wherein each elementwise exponential function is computed by:
segmenting the elementwise exponential function into a plurality of bins, wherein each bin corresponds to a specified range of an input variable x of the elementwise exponential function;
determining a bin of the plurality of bins that corresponds to the input variable x and performing a table look-up to retrieve a slope and an offset for the determined bin, wherein the slope identifies a slope of a piece-wise linear approximation of the elementwise exponential function over the specified range of the determined bin and the offset; and
computing slope*x+offset to approximate the elementwise exponential function exp(x).

14. A method comprising:
pushing a given row vector of a first matrix;
pushing a column vector of a second matrix on each of a plurality of clock cycles; and
pushing a column vector of a third matrix on each of the plurality of clock cycles after a given delay.

15. A method for performing self-attention computations by delaying performance of a division operation of a softmax computation, the performance of the self-attention computations comprising:
iteratively computing a first matrix multiplication of a given row vector of a first matrix and each column vector of a second matrix while determining a first scalar element representing a maximum value of the iterative first matrix multiplications;
iteratively subtracting a corresponding determined first scaler element from a result of each computed first matrix multiplication and computing an elementwise exponential function based on a result of the subtraction operation to generate a plurality of elements of a given row vector of a fourth matrix;
iteratively computing a second matrix multiplication of a given row vector of the fourth matrix and each column vector of a third matrix while summing the given row vectors of the fourth matrix to obtain a second scalar; and
computing a row vector of an output matrix based on results of the second matrix multiplications.

16. The method of claim 15, further comprising iteratively dividing each element of the computed row vector of the output matrix by the corresponding determined second scalar.
